(19) United States
(12) Patent Application Publication
(10) Pub. No.: US 2002/0003344 A1
(43) Pub. Date: Jan. 10, 2002

(54) Occupant protection apparatus

(76) Inventor: Yoshinori Maeda, Isehara-shi (JP)

Correspondence Address: David L. Tarnoff, Shinjyu Global IP Counselors, LLP, Suite 700, 1233 Twentieth Street, NW, Washington, DC, 20036-2680, US

(21) Appl. No.: 09/858,660

(22) Filed: May 17, 2001

(30) Foreign Application Priority Data
Jul. 4, 2000 (JP) 2000-202148

(51) Int. Cl. B60R 21/18

(52) U.S. Cl. 280/733; 280/735

(57) ABSTRACT

Load sensors detect a load from seat and a sitting object. A load sensor control unit determines whether the detected load is greater or smaller than the predetermined load. If the detected load is smaller, the air bag operation is restricted. If the detected load is greater, and if A-ELR switch that detects the state of seatbelt retractor indicates the ALR state, the air bag operation is restricted. In this manner, even when the fastening force for installing the child seat to the seatbelt is large, it is possible to avoid an unwanted deployment of the air bag from a wrongful determination that an adult is sitting. The occupant protection apparatus can determine when a child seat is installed and when an adult is sitting, and restrict the deployment of the air bag when the child seat is being installed.

### BACKGROUND OF THE INVENTION

1. Field of the Invention

The present invention relates to an occupant protection apparatus. More specifically, the present invention relates to an occupant protection apparatus that can selectively control deployment of an air bag based on whether a child seat is being used.

2. Background Information

An air bag is an occupant protection device that is often used in conjunction with a seatbelt for protecting the occupant at the time of a vehicle collision. An occupant protection device is disclosed in Japanese Laid Open Patent Application No. H11-11153 that relates to the technology of controlling an air bag. According to this publication, the air bag apparatus has a load sensor that detects the weight of the occupant seated on the vehicle seat. If the weight detected by the load sensor is small, a relatively small amount of gas is supplied to inflate the air bag. If the weight is large, a relatively large amount of gas is supplied to inflate the air bag. In this manner, the air bag apparatus can function properly regardless of the weight of the occupant.

However, in the aforementioned airbag apparatus, the occupant's weight is detected by a weight sensor that is fixed to the vehicle body. Therefore, although it is possible to distinguish between a heavy adult and a light child, it is difficult to tell apart an adult and a child seat. This difficulty occurs because a child seat is fixed to a seat by a seatbelt. Particularly, a child seat has to be secured to the seat by the seatbelt so that the child seat is stable. Since the tension of the seatbelt applies a downward force on the seat, the load on the seat as detected by the weight sensor can be comparable to the weight of an adult, depending on the amount of tension in the seatbelt.

In view of the above, there exists a need for an occupant protection apparatus which overcomes the above mentioned problems in the prior art. This invention addresses this need in the prior art as well as other needs, which will become apparent to those skilled in the art from this disclosure.

### SUMMARY OF THE INVENTION

An object of the present invention is to provide an occupant protection apparatus that can accurately distinguish between a child seat installed on a seat and an adult sitting on the seat such that the deployment of an air bag can be accurately controlled.

The aforementioned object can be attained by providing an occupant protection apparatus that comprises a weight sensor, an air bag, a child seat detector, a load sensor control unit and an air bag controller. The weight sensor is configured to detect an object's weight that is sitting on a seat. The air bag is configured to deploy at time of a collision. The child seat detector is configured to detect whether a child seat is installed on the seat by a seatbelt. The load sensor control unit is configured to determine deployment and restriction of the air bag based on a comparison between the object's weight detected by the weight sensor and a predetermined threshold load value. The load sensor control unit determines restriction in the deployment of the air bag if the child seat detector detects a child seat being installed on the seat. The air bag controller is operatively coupled to the air bag to deploy the air bag based on the determination result of the load sensor control unit.

These and other objects, features, aspects and advantages of the present invention will become apparent to those skilled, in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a partial diagrammatic, lateral cross sectional view of a vehicle interior, which includes an occupant protection apparatus in accordance with a first embodiment of the present invention;

FIG. 2 is a top schematic plan view of the occupant protection apparatus in accordance with the first embodiment of the present invention;

FIG. 3 is a flowchart of an operation of the occupant protection apparatus in accordance with the first embodiment of the present invention;

FIG. 4 is a graph showing load adjustment performed by the occupant protection apparatus in accordance with a second embodiment of the present invention;

FIG. 5 is a flowchart of an operation of the occupant protection apparatus in accordance with the second embodiment of the present invention;

FIG. 6 is a partial internal front elevational view of the seatbelt retractor in accordance with selected embodiments of the present invention and with certain parts removed for explaining the structure and operation of the seatbelt retractor with a retractor state detection switch as child seat detection means;

FIG. 7 is a cross sectional view the seatbelt retractor in accordance with selected embodiments of the present invention as viewed along section line A-A′ of FIG. 6 and with certain parts removed for explaining the structure and operation of the seatbelt retractor with a retractor state detection switch as child seat detection means;

FIG. 8 is an enlarged bottom plan view of selected parts of the seatbelt retractor with retractor state detection switch in accordance with selected embodiments of the present invention;

FIG. 9 is a partial internal front elevational view of the seatbelt retractor in accordance with selected embodiments of the present invention and with certain parts removed for showing a state (A-ELR stopper lock state) in which the webbing is fully drawn out from the seatbelt retractor;

FIG. 10 is an enlarged bottom plan view of selected parts of the seatbelt retractor in accordance with selected embodiments of the present invention, showing a state (A-ELR stopper lock state) in which the webbing is fully drawn out from the seatbelt retractor; and

FIG. 11 is a partial internal front elevational view of the seatbelt retractor in accordance with selected embodiments of the present invention and with certain parts removed for showing a state (A-ELR stopper lock release state) in which the webbing is halfway retracted by the seatbelt retractor.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only, and not for the purpose of limiting the invention as defined by the appended claims and their equivalents.

### First Embodiment

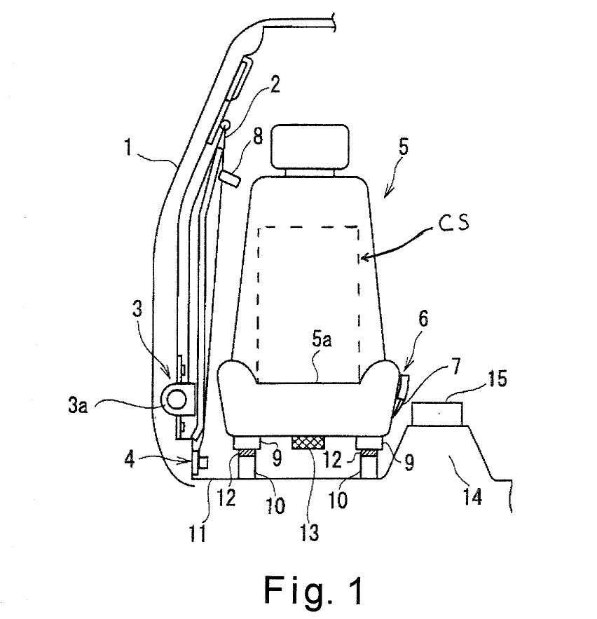

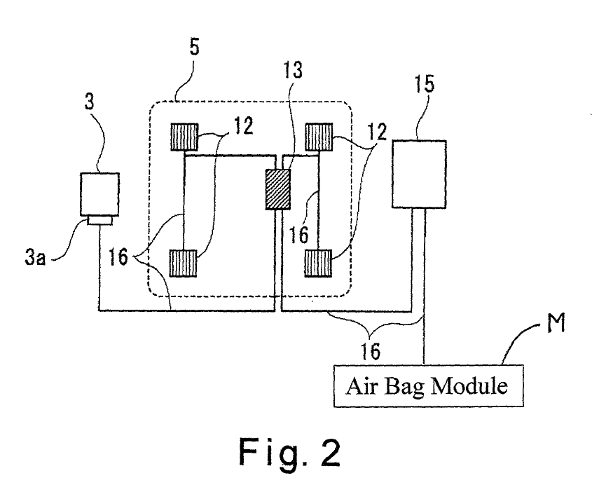

Referring initially to FIGS. 1-3, an occupant protection apparatus is illustrated in accordance with a first embodiment of the present invention. FIG. 1 is a partial diagrammatic lateral cross sectional view of a vehicle interior showing the structure of the occupant protection apparatus in accordance with the first embodiment. FIG. 2 is a top schematic plan view of the structure of the occupant protection apparatus of the first embodiment. In this embodiment, the occupant protection apparatus is provided in a front passenger's seat on a left-hand side of the vehicle. However, it is obvious that the occupant protection apparatus of the present invention can be provided in the front passenger's seat on a right-hand side of the vehicle or in either of the rear seats. A child seat CS is diagrammatically illustrated on a seat 5 of the vehicle. The child seat CS is a conventional device that is well known in the art. Since child seats are well known in the art, the child seat CS will not be discussed or illustrated in detail herein. The child seat CS is held in the seat 5 in a conventional manner by a seat belt that applies a downward force to press the child seat CS against the seat 5.

In FIG. 1, the occupant protection apparatus of the first embodiment has a seatbelt webbing 2, a seatbelt retractor 3 with an A-ELR switch 3a, a seatbelt outer side anchor 4, a seatbelt buckle 6, a seatbelt inner side anchor 7, a plurality of load sensors 12, a load sensor controller or control unit 13, and an air bag controller or control unit 15. The seatbelt retractor 3 is equipped with an A-ELR (automatic lock and emergency lock) function. The A-ELR switch 3a is located within the seatbelt retractor 3, and indicates whether the seatbelt retractor 3 is in the automatic lock state or in the emergency lock state. The A-ELR switch 3a is a conventional component that is well known in the art. Since the A-ELR switch 3a is well known in the art, the A-ELR switch 3a will not be discussed or illustrated in detail herein. The A-ELR switch 3a functions as both a child seat detection mean and a retractor detection means for indicating whether the child seat CS is installed in the seat 5. Moreover, “child seat detection mean and retractor detection means” as utilized in the claims should include any structure that can be utilized to carry out the function of detecting the presents of the child seat CS on the seat 5 in accordance with the present invention.

The load sensors 12 detect a load or weight, which is the weight of the seat 5 plus the weight of any object sitting on the seat 5. The load sensors 12 are conventional components that are well known in the art. Since load sensors are well known in the art, the load sensors 12 will not be discussed or illustrated in detail herein. Moreover, “weight sensing means” as utilized in the claims should include any structure that can be utilized to carry out the function of the load sensors 12 of the present invention.

The load sensor control unit 13 functions as a sitting object determination means that determines based on the load detected by the load sensors 12 whether the object or occupant sitting on the seat 5 is an object for which an air bag should be deployed, or an object for which the deployment of the air bag should be restricted. The air bag control unit 15 functions as an air bag control means that controls deployment of the air bag(s) of the air bag module M that is diagrammatically shown in FIG. 2, based on the determination by the load sensor control unit 13.

The control units 13 and 15 can be a single unit or a pair of units that are operatively coupled together. One or both of the control units 13 and 15 includes or is controlled by a microcomputer with a control program that controls the occupant protection apparatus as discussed below. One or both of the control units 13 and 15 can also include other conventional components such as an input interface circuit, an output interface circuit, and storage devices such as a ROM (Read Only Memory) device and a RAM (Random Access Memory) device. The memory circuit stores processing results and control programs for operation of the air bag module M. It will be apparent to those skilled in the art from this disclosure that the precise structure and algorithms for the control units 13 and 15 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

As shown in FIG. 1, the seatbelt retractor 3 is preferably installed at an inner bottom of a vehicle pillar (center pillar) 1 for the front seat 5. The seatbelt retractor 3 retracts the webbing 2 from an inner end of the webbing 2 that is attached thereto. Further underneath the seatbelt retractor 3, the other or outer end of the webbing 2 is fixed to the pillar 1 via the seatbelt outer side anchor 4.

The seatbelt inner side anchor 7 has the seatbelt buckle 6 coupled thereto. The seatbelt inner side anchor 7 is disposed on an inner side of front passenger's seat 5, such that a tongue plate 8 through which the webbing 2 passes can be coupled to and detached from the seatbelt buckle 6 in a conventional manner.

The seatbelt retractor 3 has the A-ELR switch 3a that indicates either the auto-lock state or the emergency lock state. The auto-lock state occurs after the webbing 2 is fully drawn out. During the auto-lock state, the seatbelt retractor 3 can only retract the webbing 2 until after the webbing 2 is fully retracted. The seatbelt retractor 3 is in a different state while in the emergency lock state.

The seat 5 is typically slidable in a front-rear direction of the vehicle by a pair of rails 9 that are disposed on inner and outer sides of the seat 5. Each of the rails 9 is attached to a vehicle body 11 via a bracket 10. In between the rails 9 and the brackets 10, a total of four load sensors 12 are disposed. The load sensors 12 detect the weight or load of seat 5 and the weight or load of an object sitting on the seat 5. The load sensor control unit 13 is disposed on a lower side opposite of a sitting surface 5a of the seat 5. The load sensor control unit 13 determines whether the weight or load of the object or occupant is greater or smaller than a predetermined weight or load.

The air bag control unit 15 is disposed on top of a floor tunnel 14 of the vehicle body 11 in a conventional manner. The air bag control unit 15 controls the deployment of the air bag or air bags, based on the determination by the load sensor control unit 13 and signals from the A-ELR switch 3a operatively coupled to the seatbelt retractor 3.

As seen in FIG. 2, the seatbelt retractor 3, the four load sensors 12, the load sensor control unit 13, the air bag control unit 15, and the air bag module are operatively connected to each other by a wire harness 16, such that the necessary electric signals can be sent to and received from each other.

The seatbelt retractor 3 of the present embodiment functions as an A-ELR seatbelt device, having both ELR function and ALR function. In other words, during normal use, the seatbelt retractor 3 functions as an ELR (emergency lock-type retractor device). For instance, when the speed changes suddenly due to a vehicle collision or a collision from rear, or by turning upside down, a lock mechanism is activated to lock the drawing out of the webbing 2. In the meantime, when a child seat is installed, the seatbelt retractor 3 can be switched from the ELR function to the ALR function (automatic lock-type retractor device) automatically by fully drawing the webbing 2 out of the seatbelt retractor 3.

Once the seatbelt retractor 3 shifts to the ALR function, the seatbelt retractor 3 only functions for retraction. Thus, even if the occupant tries to draw the webbing 2 out of the seatbelt retractor 3, the webbing 2 cannot be drawn out because it is locked. In this manner, the child seat can be fixedly installed in seat 5 due to this ALR function. Also, the seatbelt retractor 3 can be switched back to the ELR-functioning state from the ALR-functioning state by fully retracting the webbing 2 to its normal resting position as seen in FIG. 1.

The A-ELR switch 3a is a switch that outputs signals indicating whether the ALR function or the ELR function is in operation. For instance, the A-ELR switch 3a can be configured to be “OFF” when the ALR function is in operation, and “ON” when the ELR function is in operation.

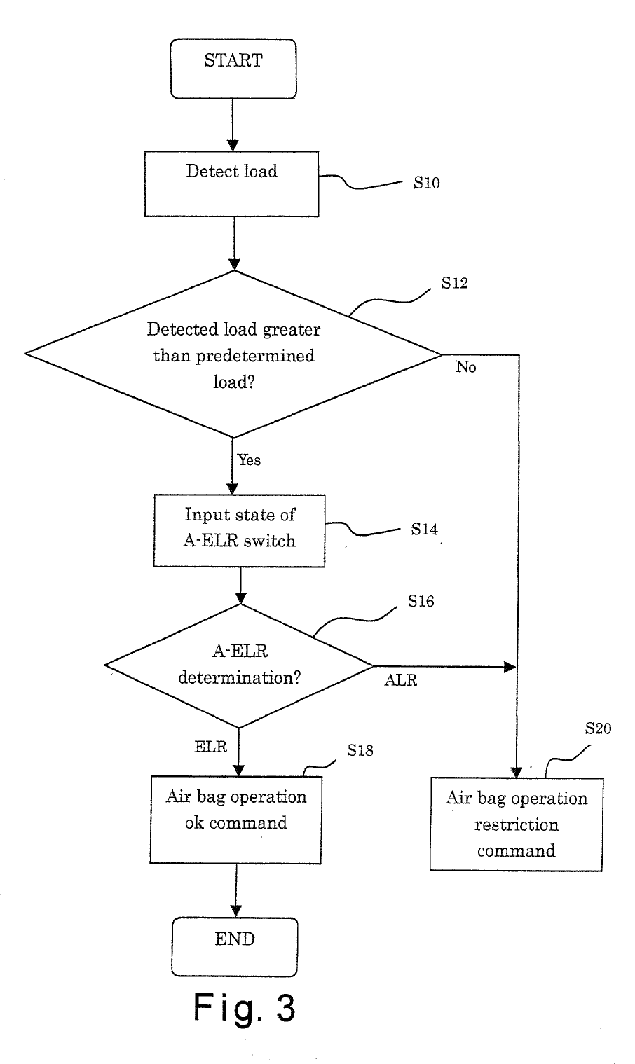

Operation of the occupant protection apparatus in accordance with the first embodiment will now be described referring to the flowchart shown in FIG. 3. First in step S10, the four load sensors 12 detect the load from the combined weight of the sitting occupant and the seat 5. Then in step S12, the load sensor control unit 13 reads the detected load value from the load sensors 1-2, and determines whether the detected load is greater or smaller than the predetermined load that is a preset value based on the weight of the seat 5 plus a preselected weight of a child. If the detected load is smaller than the predetermined load, it is determined that a child is sitting in the seat 5. Accordingly, in step S20, the load sensor control unit 13 sends an air bag operation restriction command to the air bag control unit 15. Upon receiving the air bag operation restriction command, the air bag control unit 15 executes a control to restrict the deployment of the air bag such that the occupant sitting on the seat 5 is protected, in the event the air bag has to be deployed.

If the detected load is greater than the predetermined load in the determination at step S12, then the state of the A-ELR switch 3a is inputted to the load sensor control unit 13 in step S14. Then in step S16, it is determined whether the A-ELR switch 3a is in the ALR state or in the ELR state. If the A-ELR switch 3a is in the ALR state, it is determined that a child seat is being used. Then, the system proceeds to step S20.

If the A-ELR switch 3a is in the ELR state in step S16, a child seat is not being used. Therefore, the load detected by the load sensors 12 is that of an adult sitting on the seat 5. Thus, the load sensor control unit 13 outputs an air bag operation “ok” command to the air bag control unit 15 in step S18. Upon receiving the air bag operation “ok” command, the air bag control unit 15 executes a control to deploy the air bag in the event the air bag has to be deployed, the air bag being provided to protect the occupant sitting on the seat 5.

Therefore, when a child under the preselected weight is sitting on the seat 5, the deployment of the air bag can be controlled, e.g., reduced inflation and/or no inflation of the air bag. Furthermore, the deployment of the air bag can be restricted even if the load sensors 12 detect a load that is comparable to an adult's weight because of the child seat that is installed in the seat 5 with a seatbelt.

Furthermore, in this embodiment, the A-ELR switch 3a functions as the retractor detection means and the child seat detection means. Since the A-ELR switch 3a can have a simple structure, the child seat detection means/ retractor detection means can be manufactured at a low cost.

### Second Embodiment

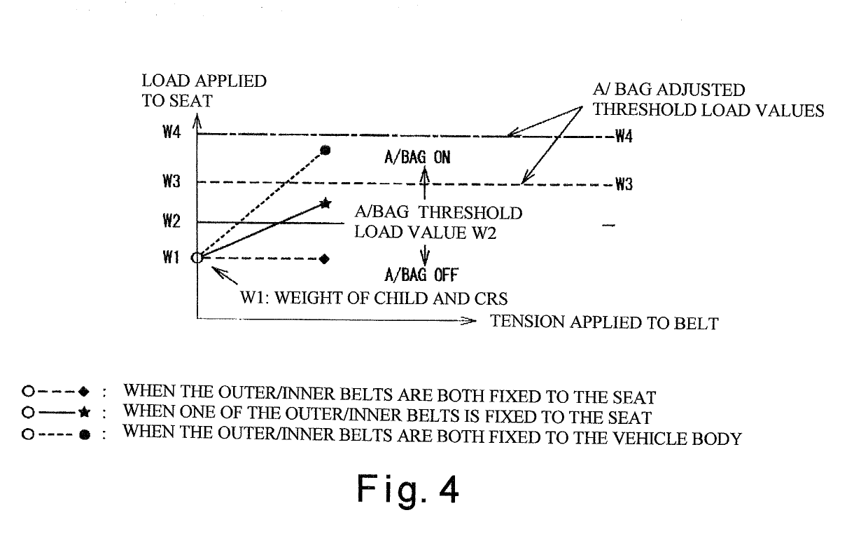

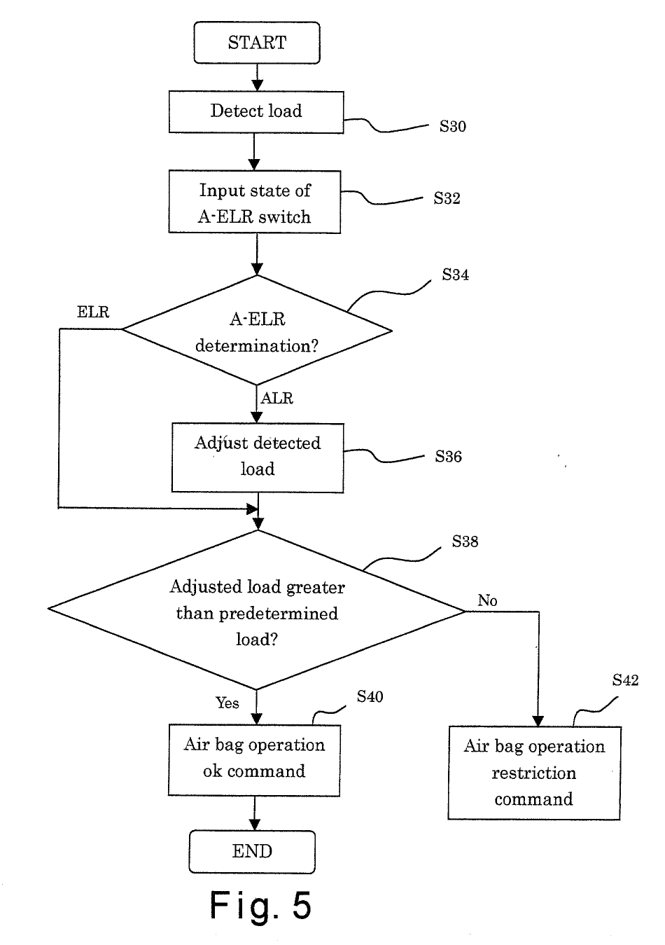

Now, a second embodiment of the present invention will be described referring to FIGS. 4 and 5. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The structure of the second embodiment is similar to that of the first embodiment shown in FIGS. 1-3. The difference between the first and second embodiments is that the load sensor control unit 13 operates differently in the second embodiment from the first embodiment. In the second embodiment, when the A-ELR switch 3a indicates the ALR state, the load sensor control unit 13 adjusts the detected load or the predetermined threshold value to take in to account the load due to the force of the seat belt applied to the child seat CS. More specifically, the occupant protection apparatus in the second embodiment has three factory settings W1, W2, W3 for the threshold load value depending on the arrangement of the seat belt relative to the seat 5 as explained below. Then, the system determines whether the object or occupant sitting on the seat 5 is an object for which the air bag should be deployed, or an object for which the air bag should not be deployed or deployed with a reduced inflation, based on either the adjusted load if in the ALR state or the detected (non-adjusted) load if in the ELR state.

Now referring to FIG. 4, the manner in which the load detected by the load sensors 12 is adjusted will be explained. First of all, assuming that the sum of the child's weight and child seat's weight (referred to as CRS in Figures) is equal to W1, then an adjustment may be necessary depending on the manner in which the seatbelt is arranged. If both of the outer and inner side anchors 4 and 7 of the seatbelt are fixed to the seat 5, then the load detected by the load sensors 12 on the seat 5 is the constant value W1, regardless of the magnitude of the tension applied to the webbing 2 of the seatbelt. In this situation, the occupant protection apparatus has a predetermined threshold load value for activating the air bag, which is set as W2, regardless of the magnitude of the tension applied to the webbing 2 of the seatbelt.

However, if one of the outer and inner side anchors 4 and 7 of the seatbelt is fixed to the seat 5, the load detected by the load sensors 12 on the seat 5 becomes greater if the tension applied to the webbing 2 of the seatbelt is greater. However, its gradient is not as large if as both of the outer and inner side anchors 4 and 7 of the seatbelt are fixed to the vehicle body 11. In this situation, the occupant protection apparatus adjusts the predetermined threshold load value for determining whether the air bag should be activated such that the adjusted predetermined threshold load value is set at W3, which is greater than the non-adjusted threshold load value W2. Instead of changing the predetermined threshold load value W2, the detected load can be decreased by an adjustment valve equal to the value W3 minus the value W2.

If both of the outer and inner side anchors 4 and 7 of the seatbelt are fixed to the vehicle body 11 (such as to the floor), the load to seat 5 as detected by the load sensors 12 on the seat 5 becomes significantly greater if the tension applied to the webbing 2 of the seatbelt is greater. In this situation, its gradient is also larger than if only one of the outer and inner side anchors 4 and 7 of the seatbelt is fixed to the seat 5. In this situation, the occupant protection apparatus adjusts the predetermined threshold load value for determining whether the air bag should be activated such that the adjusted predetermined threshold load value is set at W4, which is greater than the threshold load value W3 and the non-adjusted threshold load value W2. Instead of changing the predetermined threshold load value W2, the detected load can be decreased by an adjustment valve equal to the value W4 minus the value W2.

Next, the operation of the occupant protection apparatus in accordance with the second embodiment will be described referring to the flowchart shown in FIG. 5. First in step S30, the four load sensors 12 detect the load from the combined weight of the sitting occupant and the seat 5. Then in step S32, the state of A-ELR switch 3a is inputted to the load sensor control unit 13. The occupant protection apparatus then determines in step S34 whether the A-ELR switch 3a indicates the ALR state or the ELR state.

If the A-ELR switch 3a indicates the ALR state, an adjusted load or an adjusted predetermined threshold load value is obtained in step S36 by decreasing the detected load or by increasing the predetermined threshold value. The load sensor control unit 13 can perform this function, and thus, act as an adjustment means for making an adjustment when a child seat has been detected and for determining the seat arrangement. The amount of adjustment can be stored in the load sensor control unit 13, which is then preset for the particular seat arrangement at the time of installation of the occupant protection apparatus. In other words, the load sensor control unit 13 can have a predetermined adjustment value for each of the three different seat arrangements, as discussed above. Thus, at the time of installation of the occupant protection apparatus, the predetermined adjustment value can be set by the installer for making the correct amount of adjustment in step S36. Then, the system proceeds to step S38. If the A-ELR switch 3a indicates the ELR state, the system proceeds to step S38, skipping step S36, which is the step for adjusting the detected load.

In step S38, the system determines whether the adjusted load or the detected load (if the detected load has not been adjusted) is greater than the predetermined load. If the adjusted load is smaller than the predetermined load, it is determined that a child is sitting on the seat 5 or a child seat is being used. Then in step S42, the load sensor control unit 13 sends an air bag operation restriction command to the air bag control unit 15. Upon receiving the air bag operation restriction command, the air bag control unit 15 executes a control to restrict the deployment of the air bag such that the object or occupant sitting on the seat 5 is protected, in the event an incident occurs in which the air bag should be deployed.

In the determination step S38, if the adjusted load is greater than the predetermined load, it is determined that an adult is sitting. Then, the system proceeds to step S40. In step S40, the load sensor control unit 13 outputs an air bag operation “ok” command to the air bag control unit 15. Upon receiving the air bag operation “ok” command, the air bag control unit 15 executes a control to deploy the air bag(s) in the event an incident occurs in which the air bag(s) should be deployed occurs, such that the air bag protects the object or occupant sitting on the seat 5.

Therefore, when a child seat is being installed, the detected load from the load sensors 12 can be adjusted using a sum of the weight of the child seat and a weight equivalent to the fastening force of the seatbelt. Accordingly, even if the apparent load as detected by the load sensors 12 increases due to the child seat being tightly secured with the seatbelt, it is less possible that the child seat will be mistaken for an adult. Thus, the deployment control of the air bag can be more properly performed.

### Sealtbelt Retractor

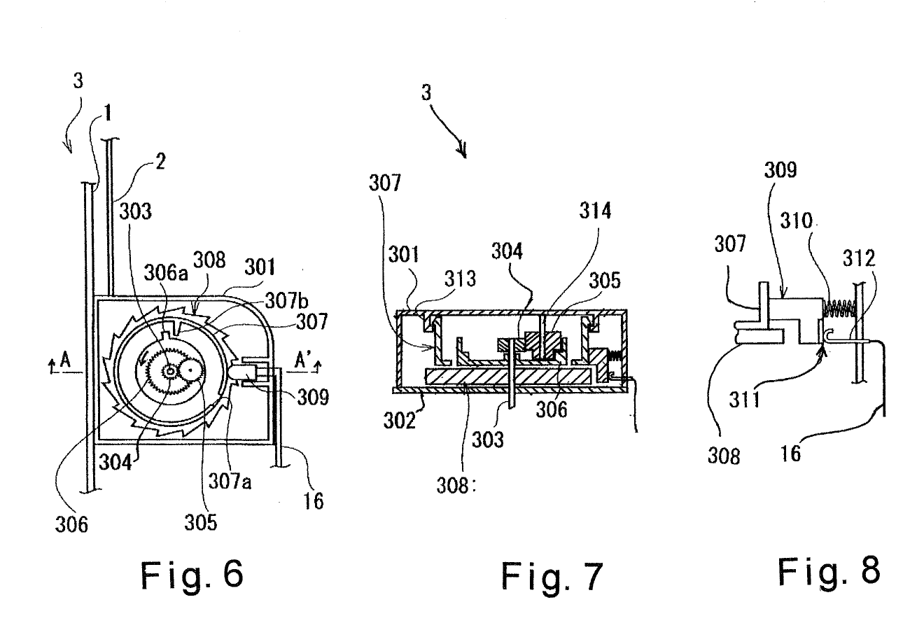

Next, referring to FIGS. 6-11, the details of the structures of the seatbelt retractor 3 and A-ELR switch 3a that can be used in the occupant protection apparatus in accordance with the first and second embodiments will be explained.

FIG. 6 is a partial internal front elevational view of the seatbelt retractor 3 in with certain parts removed for explaining the structure and operation of the seatbelt retractor 3 with the retractor state detection (A-ELR) switch 3a as a child seat detection means. FIG. 7 is a cross sectional view the seatbelt retractor 3 as viewed along section line A-A′ of FIG. 6 and with certain parts removed for explaining the structure and operation of the seatbelt retractor 3 with the retractor state detection (AELR) switch 3a. FIG. 8 is an enlarged bottom plan view of selected parts of the seatbelt retractor 3 in with the retractor state (A-ELR) detection switch 3a.

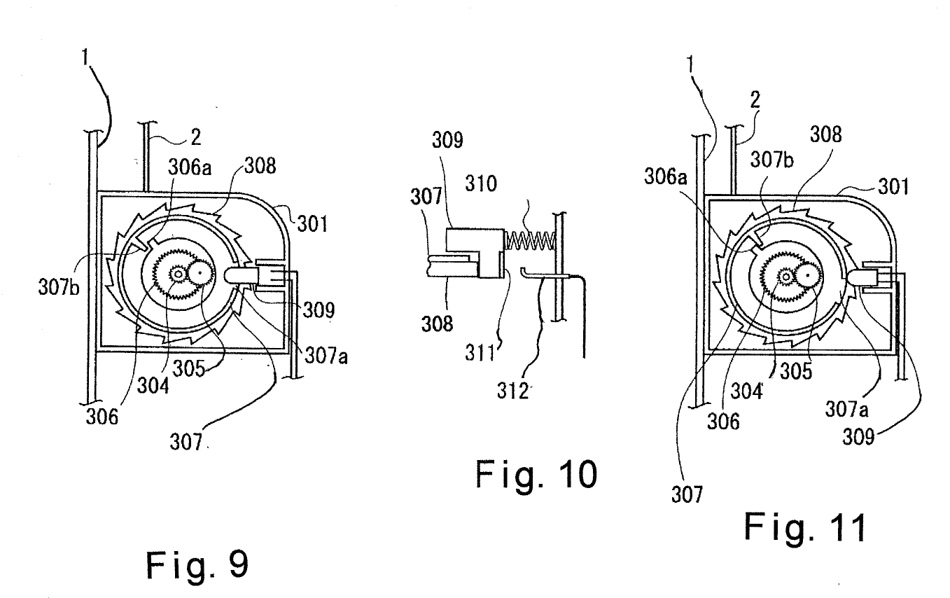

FIG. 9 is a partial internal front elevational view of the seatbelt retractor 3 with certain parts removed for showing a state (A-ELR stopper lock state) in which the webbing 2 is fully drawn out from the seatbelt retractor 3. FIG. 10 is an enlarged bottom plan view of selected parts of the seatbelt retractor 3, showing a state (A-ELR stopper lock state) in which the webbing 2 is fully drawn out from the seatbelt retractor 3. FIG. 11 is a partial internal front elevational view of the seatbelt retractor 3 with certain parts removed for showing a state (A-ELR stopper lock release state) in which the webbing 2 is halfway retracted by the seatbelt retractor 3.

This seatbelt retractor 3 basically includes a case 301, a wall 302, a seatbelt retraction drum rotational axis 303, a small gear 304, a medium gear 305, a large gear 306, a seatbelt lock gear 308, a guide 313, an A-ELR stopper lock release rotary body 307, a cutout 307a, an A-ELR stopper 309, a coil spring 310, an electric conductor 311, and a spring terminal 312. The case 301 is fixedly attached to the pillar 1 of the vehicle body 11 in a conventional manner and accommodates the A-ELR lock mechanism. The wall 302 divides the inside of the case 301 from a seatbelt retraction drum portion, which is not shown in Figures. The seatbelt retraction drum rotational axis 303 passes through the wall 302. The small gear 304 is fixed to the seatbelt retraction drum rotational axis 303. The medium gear 305 is a two-level gear. The medium gear 305 is rotatable about a medium gear axis 314 that is fixed to the case 301. A large diameter portion of the medium gear 305 meshes with the small gear 304. The seatbelt lock gear 308 is rotatable about the seatbelt retraction drum rotational axis 303. The guide 313 is a cylindrical protrusion formed within the case 301. The A-ELR stopper lock release rotary body 307 is rotatably coupled to the guide 313. The cutout 307a is formed on an outer peripheral portion of the A-ELR stopper lock release rotary body 307. The A-ELR stopper 309 can be inserted into the cutout 307a. The coil spring 310 biases the A-ELR stopper 309 toward the A-ELR stopper lock release rotary body 307. The electric conductor 311, such as a copper plate, is fixedly attached to a coil spring side of the A-ELR stopper 309. The spring terminal 312 is disposed opposite the electric conductor 311. When the A-ELR stopper 309 is inserted to cutoff 307a, the spring terminal 312 separates from the electric conductor 311. When the A-ELR stopper 309 is not inserted into the cutoff 307a, the spring terminal 312 contacts the electric conductor 311.

Now, the operation of the seatbelt retractor 3 will be explained. The small gear 304, the medium gear 305, and the large gear 306 are gears for adjusting the number of rotations. The gears 304-306 transmit and adjust rotations by reducing the number of rotations of the seatbelt retraction drum rotational axis 303. In other words, the seatbelt retraction drum, which is not shown in Figures and to which the webbing 2 is wound, rotates when the webbing 2 is drawn out from the seatbelt retractor 3. Accordingly, the seatbelt retraction drum rotational axis 303 also rotates when the webbing 2 is drawn out from the seatbelt retractor 3. Then, the small gear 304 that is fixedly attached to the seatbelt retraction drum-rotational axis 303 rotates when the webbing 2 is drawn out from the seatbelt retractor 3. This rotary force is subsequently transmitted from the small gear 304 to the medium gear 305, and then from the medium gear 305 to the large gear 306.

While the webbing 2 is fully drawn out from the seatbelt retractor 3, the number of rotations of the seatbelt retraction drum rotational axis 303 is reduced in two levels and transmitted to the large gear 306. Accordingly, the large gear 306 slowly rotates in the counterclockwise direction once, while the webbing 2 is fully drawn out. Once the webbing 2 is fully drawn out, a protrusion 306a formed on an outer peripheral portion of the large gear 306 contacts a protrusion 307b formed inside the A-ELR stopper lock release rotary body 307. Then, the protrusion 306a pushes the protrusion 307b in the counterclockwise direction.

In this manner, the cutoff 307a of the A-ELR stopper lock release rotary body 307 comes to a position that opposes the A-ELR stopper 309. Then, the A-ELR stopper 309 is pushed to the left hand side of FIG. 10 by the coil spring 310. Accordingly, the A-ELR stopper 309 engages the cutoff 307a. At this time, a bottom portion of the A-ELR stopper 309 meshes with the seatbelt lock gear 308. Thereafter, as seen in FIG. 9, rotation of the seatbelt retraction drum rotational axis 303, which is fixedly attached to the seatbelt lock gear 308, is restricted from operating in the direction to draw out the webbing 2.

The ALR state shown in FIG. 9. In the ALR state, the A-ELR switch 3a that includes the electric conductor 311 and the spring terminal 312 is in an open (OFF) state. Conversely, in the ELR state in which the webbing 2 is halfway retracted, the A-ELR stopper 309 is separated from the cutoff 307a of the A-ELR stopper lock release rotary body 307, as seen in FIG. 10. Accordingly, the A-ELR switch 3a that includes the electric conductor 311 and the spring terminal 312 is in a closed (ON) state.

In this manner, the A-ELR switch 3a can report to the load sensor control unit 13 whether the seatbelt retractor 3 is in the ALR state or in the ELK state by sending either an OFF or an ON signal. Therefore, a retractor state detection signal can be obtained as a signal from a low-cost and reliable switch.

As used herein, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The terms of degree such as “substantially”, “about” and “approximately” as used herein mean a reasonable amount of deviation of the modified term such that the end result is not significantly changed. These terms should be construed as including a deviation of ±5% of the modified term if this would not negate the meaning of the word it modifies.

This application claims priority to Japanese Patent Application No. 2000-202148. The entire disclosure of Japanese Patent Application No. 2000-202148 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An occupant protection apparatus, comprising:
a weight sensor configured to detect an object's weight that is sitting on a seat;
an air bag configured to deploy at time of a collision;
a child seat detector configured to detect whether a child seat is installed on the seat by a seatbelt;
a load sensor control unit configured to determine deployment and restriction of said air bag based on a comparison between the object's weight detected by said weight sensor and a predetermined threshold load value, said a load sensor control unit being further configured to determine restriction in the deployment of said air bag if said child seat detector detects a child seat being installed on the seat; and
an air bag controller operatively coupled to said air bag to deploy said air bag based on a determination result of said load sensor control unit.

2. The occupant protection apparatus as set forth in claim 1, wherein
said child seat detector includes a retractor state detector that detects whether a seatbelt retractor is in a locked state to install a child, and that is only able to retract said seatbelt until after said seatbelt has been fully retracted from said locked state.

3. The occupant protection apparatus as set forth in claim 2, wherein
said retractor state detector includes a lock state detection switch that detects a state of a lock member that maintains a seatbelt rotary body in either a rotatable state or a locked state.

4. An occupant protection apparatus, comprising:
a weight sensor configured to detect an object's weight that is sitting on a seat;
an air bag configured to deploy at time of a collision;
a child seat detector configured to detect whether a child seat is installed on the seat by a seatbelt;
a load sensor control unit configured to determine deployment and restriction of said air bag based on a comparison between the object's weight detected by said weight sensor and a predetermined threshold load value;
an air bag controller operatively coupled to said air bag to deploy said air bag based on a determination result of said load sensor control unit; and
an adjustment unit configured to decease the object's weight detected by said weight sensor or increase said predetermined threshold load value upon said child seat detector detects a child seat being installed on the seat by the seatbelt.

5. The occupant protection apparatus as set forth in claim 4, wherein
said child seat detector includes a retractor state detector that detects whether a seatbelt retractor is in a locked state to install a child, and that is only able to retract said seatbelt until after said seatbelt has been fully retracted from said locked state.

6. The occupant protection apparatus as set forth in claim 5, wherein
said retractor state detector includes a lock state detection switch that detects a state of a lock member that maintains a seatbelt rotary body in either a rotatable state or a locked state.

7. The occupant protection apparatus as set forth in claim 4, wherein
said adjustment unit includes a plurality of predetermined adjustment values that are based on force applied to said weight sensor by the seatbelt holding the child seat on the seat.

8. An occupant protection apparatus, comprising:
weight sensing means for detecting a weight of an object that is sitting on a seat;
an air bag that is deployed at the time of a collision and protects the object on the seat;
child seat detection means for detecting whether a child seat is installed in the seat with a seatbelt;
sitting object determination means for determining whether said air bag should be deployed or restricted for the object based on a comparison between the weight detected by said weight sensor and a predetermined threshold load value, said sitting object determination means further determining restriction of said air bag if said child seat detection means detects a child seat being installed; and
air bag control means for controlling the deployment of said air bag based on the determination result of said sitting object determination means.

9. The occupant protection apparatus as set forth in claim 8, wherein
said child seat detection means includes retractor state detection means that detects whether a seatbelt retractor is in a locked state to install a child, and that is only able to retract said seatbelt until after said seatbelt has been fully retracted from said locked state.

10. The occupant protection apparatus as set forth in claim 9, wherein
said retractor state detection means includes a lock state detection switch that detects a state of a lock member that maintains a seatbelt rotary body in either a rotatable state or a locked state.

11. An occupant protection apparatus, comprising:
weight sensing means for detecting a weight of an object that is sitting on a seat;
an air bag that is deployed at the time of a collision and protects the object on the seat;
child seat detection means for detecting whether a child seat is installed in the seat with a seatbelt;
sitting object determination means for determining whether said air bag should be deployed or restricted for the object based on a comparison between the weight detected by said weight sensor and a predetermined threshold load value;
air bag control means for controlling deployment of said air bag based on a determination result by said sitting object determination means; and
adjustment means for making an adjustment by decreasing the weight detected by said weight sensor or by increasing said predetermined value when said child seat detection means detects a child seat being installed.

12. The occupant protection apparatus as set forth in claim 11, wherein
said child seat detection means includes retractor state detection means that detects whether a seatbelt retractor is in a locked state to install a child, and that is only able to retract said seatbelt until after said seatbelt has been fully retracted from said locked state.

13. The occupant protection apparatus as set forth in claim 12, wherein
said retractor state detection means includes a lock state detection switch that detects a state of a lock member that maintains a seatbelt rotary body in either a rotatable state or a locked state.

14. The occupant protection apparatus as set forth in claim 11, wherein
said adjustment means includes a plurality of predetermined adjustment values that are based on force applied to said weight sensing means by the seatbelt holding the child seat on the seat.
